(19) United States
(12) Patent Application Publication
(10) Pub. No.: US 2014/0111392 A1
(43) Pub. Date: Apr. 24, 2014

(54) Planar Waveguide, Waveguide Filter, and Antenna

(71) Applicant: Huawei Technologies Co., LTD, Shenzhen (CN)

(72) Inventor: Jian Ou, Shenzhen (CN)

(21) Appl. No.: 14/144,026

(22) Filed: Dec. 30, 2013

Related U.S. Application Data
(63) Continuation of application No. PCT/CN2012/085303, filed on Nov. 27, 2012.

(30) Foreign Application Priority Data
Nov. 29, 2011 (CN) 201110387482.7

(51) Int. Cl. H01Q 13/10; H01P 5/08

(52) U.S. Cl. CPC H01Q 13/106; H01P 5/08
USPC 343/767; 333/24 R

(57) ABSTRACT

A planar waveguide includes a top PCB, a bottom PCB, multiple shielding metal blocks, and a metal plate. The top PCB has a groove. The groove and the bottom PCB form an air waveguide. Microstrips are disposed on the lower surface of the top PCB. The microstrips are positioned at both ends of the groove and disposed along an extension line of the groove. The multiple shielding metal blocks are disposed along the extension direction of the microstrips and the groove and positioned on both sides of the microstrips and the groove. A first conversion piece for implementing signal transmission between the microstrips and the air waveguide is further disposed between the microstrips and the bottom PCB under the groove.

### CROSS-REFERENCE TO RELATED APPLICATIONS

This application is a continuation of International Application No. PCT/CN2012/085303, filed on Nov. 27, 2012, which claims priority to Chinese Patent Application No. 201110387482.7, filed on Nov. 29, 2011, both of which are hereby incorporated by reference in their entireties.

### TECHNICAL FIELD

The present disclosure relates to the field of radio communication technologies and, in particular embodiments, to a planar waveguide, a waveguide filter, and an antenna.

### BACKGROUND

A waveguide is a pipeline that is capable of confining and guiding an electromagnetic wave to propagate in a lengthwise direction. In a microwave electronic device, a waveguide formed of a printed circuit board (PCB) microstrip or a waveguide formed of a metal cavity is generally used to control a conduction path of microwave control signals, and functions such as filtering, power splitting and combining, and coupling microwave signals are achieved by controlling and changing a shape of the microstrip or a shape of the metal cavity.

However, both of the two methods for forming a waveguide have certain limitations. The waveguide formed of the PCB microstrip is cost-efficient and easy to process, but leads to a great signal loss for a band higher than 40 GHz. Moreover, due to a high dielectric constant of a PCB medium, an impedance feature of the microstrip is largely affected by a size of the microstrip, and the PCB requires very high machining precision. This causes a sharp rise in costs and reduces the first pass yield. A rectangular or circular waveguide formed of the metal cavity causes a low signal loss, but for a band higher than 40 GHz, a machining precision tolerance of the metal cavity reaches the magnitude of micrometers, and the shape of the waveguide is stereoscopic. This requires a mold and a machining process with an extremely high precision and leads to a sharp rise in costs.

### SUMMARY OF THE INVENTION

Embodiments of the present disclosure provide a planar waveguide, a waveguide filter, and an antenna to solve problems that occur on two types of waveguides on a band higher than 40 GHz in the prior art to some extent.

An embodiment of the present disclosure provides a planar waveguide, including a top printed circuit board PCB, a bottom PCB, multiple shielding metal blocks with their upper surfaces contacting the top PCB and with their lower surfaces contacting the bottom PCB, and a metal plate disposed on the upper surface of the top PCB. The top PCB has a groove. The groove and the bottom PCB form an air waveguide. Microstrips are disposed on the lower surface of the top PCB. The microstrips are positioned at both ends of the groove and are disposed along an extension line of the groove. The multiple shielding metal blocks are disposed along the extension direction of the microstrips and the groove and positioned on both sides of the microstrips and the groove. A first conversion piece for implementing signal transmission between the microstrips and the air waveguide is further disposed between the microstrips and the bottom PCB under the groove. A working barycentric frequency of the planar waveguide is f0, a wavelength of an electromagnetic wave in the air under frequency f0 is λ=c/f0, where c is a velocity of light in the air, a height H_{b} of the shielding metal blocks fulfills 0.75×λ/4≦H_{b}≦1.25×α/4, a width W_{b} of the shielding metal blocks fulfills λ/8≦W_{b}≦λ, and a gap W_{g} between the shielding metal blocks fulfills 0<W_{g}≦λ/2.

An embodiment of the present disclosure further provides a waveguide filter, including at least two waveguides connected in series and/or in parallel, where the waveguides are the planar waveguides, and each waveguide has different impedance.

An embodiment of the present disclosure further provides an antenna, including the planar waveguide, where a window is disposed on a metal plate of the planar waveguide, the window is positioned above a groove of a top PCB of the planar waveguide, a width W, of the window fulfills 0<Wₐ≦λ/2, and a length Lₛ of the window fulfills 0<Lₛ≦λ/8.

According to the planar waveguide provided in embodiments of the present disclosure, a bottom PCB, a top PCB, and a metal plate disposed on the upper surface of the top PCB are used to constitute an upper surface and a lower surface of a waveguide. Multiple shielding metal blocks are used to constitute a left sidewall and a right sidewall of the planar waveguide, and a groove is disposed on the top PCB to form an air waveguide. When the air waveguide is used together with microstrips, a tolerance requirement of the air waveguide under a high band is lower than that of other types of waveguides, and costs of the air waveguide are far lower than costs of a rectangular waveguide. In addition, although gaps exist between the shielding metal blocks, a seamless pipeline is formed for microwave signals on a target band.

### BRIEF DESCRIPTION OF THE DRAWINGS

To illustrate the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of a planar waveguide according to a first embodiment of the present disclosure;

FIG. 2 is an exploded view of the planar waveguide shown in FIG. 1;

FIG. 3 is a partial schematic diagram of a groove after a top PCB 1 in FIG. 2 is tipped over for 180 degrees;

FIG. 4 is an exploded view of a structure of a planar waveguide according to a second embodiment of the present disclosure;

FIG. 5 is a cross-sectional view of the planar waveguide shown in FIG. 4 in an X direction;

FIG. 6 is a partial cross-sectional view of the planar waveguide shown in FIG. 4 in a Y direction;

FIG. 7 is a partial view of a structure of a planar waveguide according to a third embodiment of the present disclosure;

FIG. 8 is a schematic structural diagram of a second conversion piece 9 according to an embodiment of the present disclosure; and

FIG. 9 is a schematic structural diagram of an antenna according to an embodiment of the present disclosure.

### DETAILED DESCRIPTION OF ILLUSTRATIVE EMBODIMENTS

To make the objectives, technical solutions, and advantages of the embodiments of the present disclosure more comprehensible, the following clearly describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

A waveguide is a structure for confining or guiding an electromagnetic wave. The electromagnetic wave may be confined and guided to propagate in a lengthwise direction of the waveguide by using the waveguide. Generally, depending on this feature of the waveguide, a finished device such as a filter or an antenna may be manufactured. Certainly, the waveguide may also be machined and manufactured as an independent component.

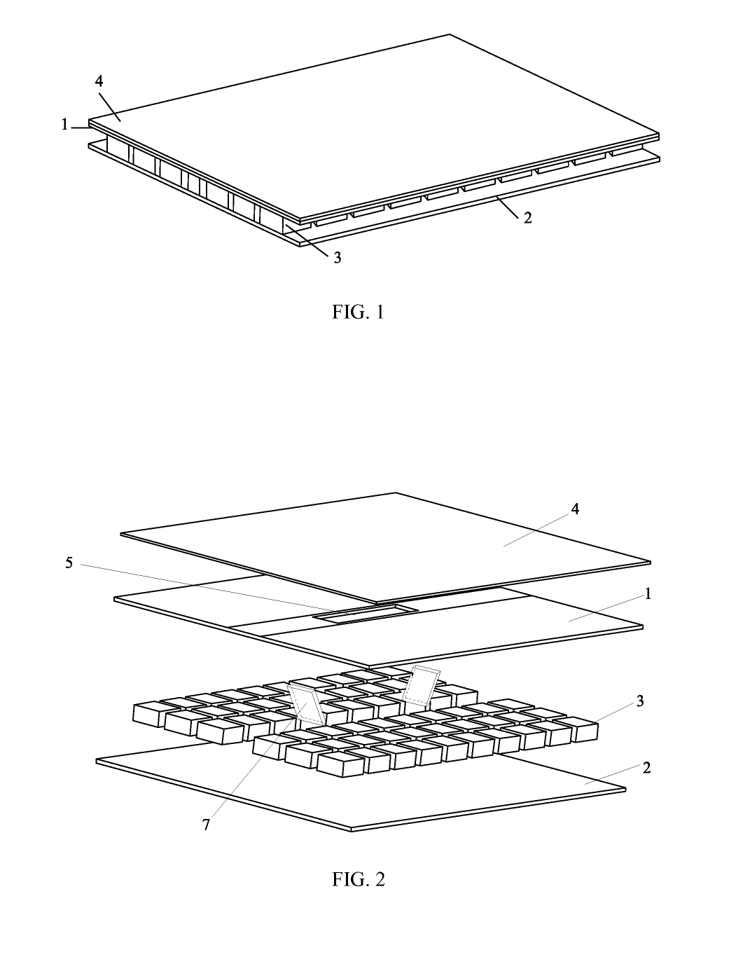

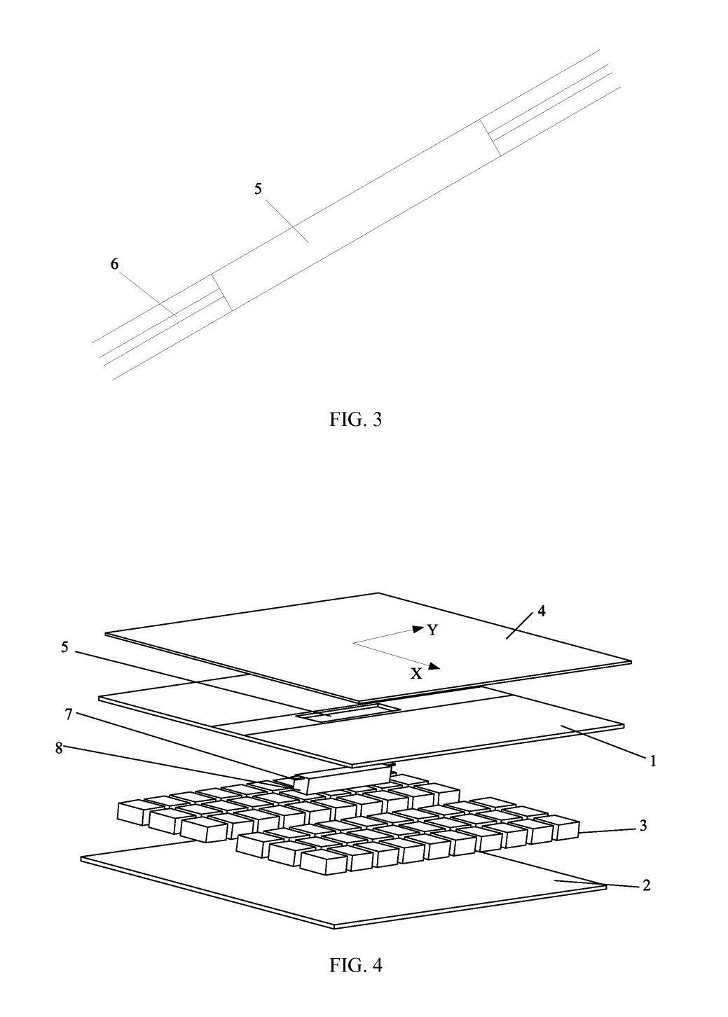

FIG. 1 is a schematic structural diagram of a planar waveguide according to a first embodiment of the present disclosure. FIG. 2 is an exploded view of the planar waveguide shown in FIG. 1 and FIG. 3 is a partial schematic diagram of a groove after a top PCB 1 in FIG. 2 is tipped over for 180 degrees. With reference to content shown in FIG. 1 to FIG. 3, the planar waveguide includes a top PCB 1, a bottom PCB 2, multiple shielding metal blocks 3, and a metal plate 4 disposed on the upper surface of the top PCB 1. Upper surfaces of these shielding metal blocks contact the top PCB 1, lower surfaces of these shielding metal blocks contact the bottom PCB 2, and the metal plate 4 may be connected to a copper coating on the upper surface of the top PCB 1 by using a conductive connection manner such as welding, bonding, or crimping.

A groove 5 is disposed on the top PCB 1. The groove 5 and the bottom PCB 2 may form an air waveguide. Microstrips 6 are disposed on the lower surface of the top PCB 1 and the microstrips 6 are positioned at both ends of the groove 5 and disposed along an extension line of the groove 5. The groove 5 and the microstrips 6 connected at both ends of the groove confine a lengthwise path of transmission of an electromagnetic wave. The multiple shielding metal blocks 3 are disposed along the extension direction of the microstrips 6 and the groove 5 and positioned on both sides of the microstrips 6 and the groove 5. The shielding metal blocks 3 on the both sides constitute a left sidewall and a right sidewall of the planar waveguide. A first conversion piece 7 for implementing signal transmission between the microstrips and the air waveguide is further disposed between the microstrips 6 and the bottom PCB 2 under the groove 5.

A main function of the first conversion piece 7 is leading microwave signals conducted on the top PCB 1 into the air waveguide. A main reason for doing this is that assembling a component such as an integrated circuit onto a PCB is the most mature manner. Therefore, after being output from the integrated circuit, signals are transmitted on the PCB. However, transmitting the signals on the PCB incurs a high loss and a low performance. If these signals output by the integrated circuit are led into the air waveguide, a loss is low, performance is high, and a very high system performance can be achieved. Therefore, the signals on the PCB need to be led into the air waveguide. The first conversion piece 7 may be connected to the microstrips 6 laid on the lower surface of the top PCB 1 by using a conductive connection manner such as welding, bonding, or crimping.

In this embodiment of the present disclosure, the first conversion piece 7 may be a metal fin. The metal fin may be of any shape, and is preferably a rectangular metal fin with a certain thickness, as shown in FIG. 2. Alternatively, the first conversion piece 7 may be a wedge, the bottom of the wedge contacts the bottom PCB 2, and the tip of the wedge is positioned on the bottom PBC 2. In an implementation manner, a length of the bottom of the wedge fulfills L_{q}≧λ/8, a thickness of the tip of the wedge fulfills 0<T_{q}≦λ/8, and a lateral height H_{q} of the wedge is equal to a height H_{b} of the shielding metal blocks 3.

Assuming that a working barycentric frequency of the planar waveguide designed in this embodiment is f0, a wavelength of an electromagnetic wave in the air under frequency f0 is λ=c/f0, where c is a velocity of light in the air, the height H_{b} of the shielding metal blocks 3 fulfills 0.75×λ/4≦H_{b}≦1.25×λ/4, a width W_{b} of the shielding metal blocks 3 fulfills λ/8≦W_{b}≦λ, and a gap W_{g} between the multiple shielding metal blocks 3 fulfills 0<W_{g}≦λ/2. Preferably, the height H_{b} of the shielding metal blocks 3 is equal to λ/4. Preferably, the width W_{b} of the shielding metal blocks 3 is equal to λ/2. Preferably, the gap W_{g} between the multiple shielding metal blocks 3 is equal to λ/4.

It should be noted that although gaps exist between the multiple shielding metal blocks 3 that meet the foregoing requirements, a seamless pipeline is formed for microwave signals on a target band. In an alternative embodiment, the multiple shielding metal blocks 3 may be disposed at equal intervals or may be disposed at unequal intervals. A shape of a shielding metal block 3 may be a triangular prism, a cylinder, a polygonal prism, or the like, and is preferably a cuboid/cube shown in the each figure. The shielding metal blocks 3 may be disposed along the extension direction of the microstrips 6 and the groove 5, and a row of shielding metal blocks are disposed on each of both sides of the microstrips 6 and the groove 5. The shielding metal blocks 3 may also be disposed asymmetrically, or disposed in multiple rows.

Each component of the planar waveguide may be manufactured and implemented by using a PCB surface-mount technology. A tolerance requirement of the planar waveguide under a high band is lower than that of other types of waveguides, and costs of the planar waveguide are far lower than costs of a rectangular/circular waveguide.

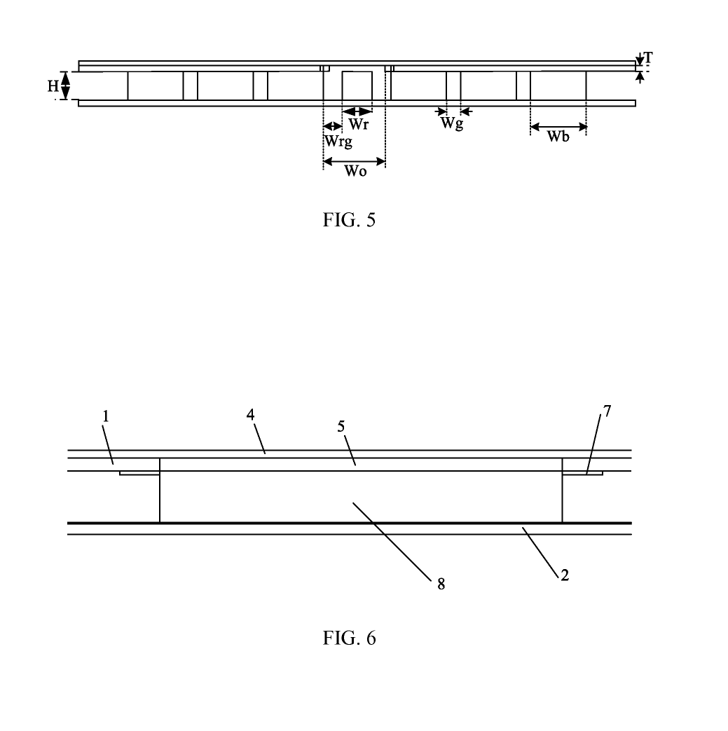

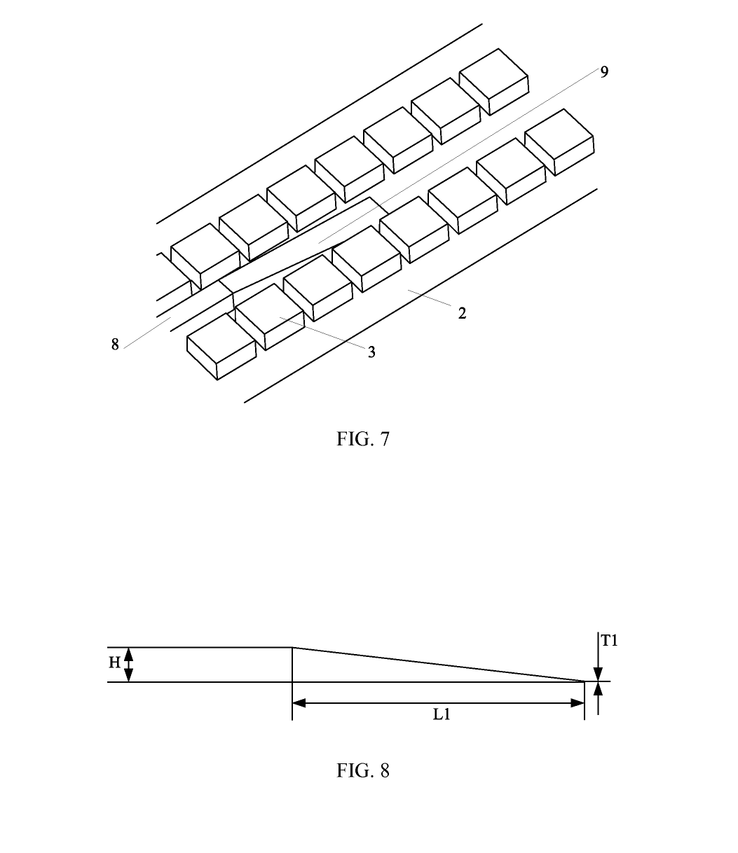

FIG. 4 is an exploded view of a structure of a planar waveguide according to a second embodiment of the present disclosure. FIG. 5 is a cross-sectional view of the planar waveguide shown in FIG. 4 in an X direction and FIG. 6 is a partial cross-sectional view of the planar waveguide shown in FIG. 4 in a Y direction. A difference from the planar waveguide shown in FIG. 1 to FIG. 3 lies in that this planar waveguide further includes a waveguide beam 8. The waveguide beam 8 is disposed on the bottom PCB 2 and positioned exactly under the groove 5, and its height is equal to a height of shielding metal blocks 3. Correspondingly, the air waveguide is formed of the upper surface of the waveguide beam 8 and the groove 5. In addition, one end of a first conversion piece 7 is connected to microstrips 6, and the other end of the first conversion piece 7 is connected to the waveguide beam 8.

If there are multiple grooves 5, multiple waveguide beams 8 may exist correspondingly. It is possible that no shielding metal block 3 exists between the multiple waveguide beams 8 to construct a coupling structure. In this case, the shielding metal blocks 3 may be positioned on both sides of the outmost groove or waveguide beam.

FIG. 7 is a partial view of a planar waveguide according to a third embodiment of the present disclosure. A difference from the planar waveguide shown in FIG. 4 to FIG. 6 lies in that this planar waveguide further includes a second conversion piece 9. One end of the second conversion piece 9 is connected to an end surface of a waveguide beam 8, and the other end of the second conversion piece 9 is connected to a bottom PCB 2 under a groove 5, so as to transmit, to the bottom PCB 2, signals propagated in an air waveguide constituted by the waveguide beam 8 and the groove 5.

It should be noted that in the third embodiment, a dimension of the waveguide beam 8 is different from a dimension of the waveguide beam 8 in the second embodiment. In the second embodiment, the dimension of the waveguide beam 8 corresponds to a dimension of the groove 5. That is, the waveguide beam 8 is exactly under the groove 5, and a length of the waveguide beam 8 corresponds to a length of the groove 5. In the third embodiment, the dimension of the waveguide beam 8 may be less than the dimension of the groove 5. A reason lies in that the second conversion piece 9 is added. Both the second conversion piece 9 and the waveguide beam 8 can be positioned under the groove 5, and therefore the sum of lengths of the second conversion piece 9 and the waveguide beam 8 may be less than or equal to the length of the groove 5.

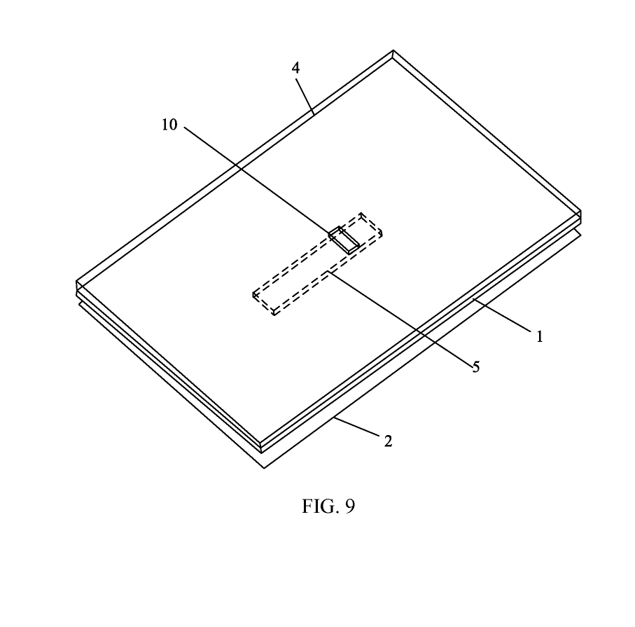

The second conversion piece 9 may be understood as a conversion piece converted from a case with a beam to a case without a beam, and its schematic structural diagram may be shown in FIG. 8. A shape of the second conversion piece 9 is preferably a wedge, the bottom of the wedge contacts the bottom PCB 2, and the tip of the wedge is positioned on the bottom PBC 2. In an implementation manner, a length of the bottom of the wedge fulfills L_{q}≧λ/8, a thickness T_{q} of the tip of the wedge fulfills 0<T_{q}≦λ/8, and a lateral height of the wedge is equal to a height H_{b} of the shielding metal blocks 3. “Equal” may be understood as substantially equal herein. It may be understood that a tiny error is allowed between the height H_{q} of the wedge and the height H_{b} of the shielding metal blocks 3.

The first conversion piece 7 may be a metal fin, as shown in FIG. 1 or FIG. 4, or may be a wedge structure, as shown in FIG. 8, and therefore no further details are provided herein.

In an alternative embodiment, no pattern is etched on a position of a copper coating of the bottom PCB 2, where the position corresponds to the waveguide beam 8 and the shielding metal blocks 3 and remains a complete copper coating. The copper coating of the bottom PCB 2 may be connected to the waveguide beam 8 and lower surfaces of the shielding metal blocks 3 by using a conductive connection manner such as welding, bonding, or crimping. A copper coating adheres to the lower surface of the top PCB 1, and the copper coating on the lower surface of the PCB 1 may be connected to upper surfaces of the multiple shielding metal blocks 3 by using a conductive connection manner such as welding, bonding, or crimping. The length of the groove 5 of the top PCB 1 may be equal to the length of the waveguide beam 8. In addition, a sidewall metallization process may be performed in the groove 5. A purpose of using the sidewall metallization process is to prevent microwave signals from leaking from the waveguide into a PCB medium herein.

For ease of description, a working barycentric frequency of the waveguide is defined as f0. Under the frequency, a wavelength of an electromagnetic wave in the air is λ=c/f0, where c is a velocity of light in the air. In addition, assuming that a relative dielectric constant of the top PCB 2 medium is ∈, and, a width of the microstrips, whose impedance is a target designed impedance Z₀, on the top PCB 1 is Wₘ,

a thickness T_{d} of the top PCB 1 medium fulfills 0<T_{d}≦λ/8;

the height H_{b} of the shielding metal blocks 3 fulfills 0.75×λ/4≦H_{b}≦1.25×λ/4;

the width W_{b} of the shielding metal blocks 3 fulfills λ/8≦W_{b}≦λ;

a gap W_{g} between the multiple shielding metal blocks 3 fulfills 0<W_{g}≦λ/2; and

a width Wₒ of the groove 5 of the top PCB 1 fulfills Wᵣ<Wₒ≦λ, where Wᵣ is a width of the waveguide beam 8.

The width of the waveguide beam 8 is Wᵣ=Wₘ×SQRT(∈)×1.4, and in this case, the impedance of the waveguide matches Z₀, where Wₘ is the width of the microstrips, whose impedance is the target designed impedance Z₀, on the top PCB 1, and SQRT(∈) is used to indicate the square root of ∈.

A gap W_{rg} between the waveguide beam 8 and the shielding metal blocks 3 fulfills 0<W_{rg}≦λ.

When the first conversion piece 7 is a metal fin, its thickness Tᵣ fulfills 0<Tₜ≦λ/8.

When the first conversion piece 7 is the metal fin, its width Wₜ fulfills 0<Wₜ≦Wᵣ.

When the first conversion piece 7 and the second conversion piece 9 are both wedge structures, a length L_{q} of bottoms of them fulfills L_{q}≧λ/8.

When the first conversion piece 7 and the second conversion piece 9 are both wedge structures, a thickness T_{q} of tips of them fulfills 0<T_{q}≦λ/8.

Based on the foregoing planar waveguide, an embodiment of the present disclosure further provides a waveguide filter. The waveguide filter includes at least two waveguides connected in series and/or in parallel. Each waveguide may be the planar waveguide provided in the foregoing embodiment, and each waveguide has different impedance, so that a waveguide filter with a high Q value can be implemented.

Based on the foregoing planar waveguide, a window 10 is disposed on a metal plate 4 of the planar waveguide. The window 10 is positioned over a groove 5 of a top PCB 1 of the planar waveguide, a width Wₛ of the window 10 fulfills 0<Wₛ≦λ/2, and a length Lₛ of the window 10 fulfills 0<Lₛ≦λ/8. In this case, a filter or an antenna may be implemented, as shown in FIG. 9, which is a schematic structural diagram of an antenna according to an embodiment of the present disclosure.

In conclusion, according to the planar waveguide, the waveguide filter, and the antenna provided in the embodiments of the present disclosure, a waveguide is manufactured and implemented by using a PCB surface-mount technology, a tolerance requirement on the waveguide under a high band is lower than that of other types of waveguides, and costs of the waveguide are far lower than costs of a rectangular waveguide. In this way, the waveguide and the PCB is designed on a same board, and a duplexer and an antenna with low insertion losses are implemented on the PCB. In addition, conversion from microstrips to an air waveguide is implemented in a simple and cost-efficient manner, a distance from antenna feeder parts to a monolithic microwave integrated circuit component is shortened to the utmost extent, and system performance is improved. Changes in a width and a height of the waveguide may affect transmission of microwaves with a specific frequency in the waveguide.

That only microwave signals with a specific frequency are allowed to pass through the waveguide can be implemented by designing a series combination of the width and the height of the waveguide, thereby forming a filter. The performance of the waveguide is higher than that of the PCB. Although a filter may be formed by changing a width of the microstrips on the PCB, the performance of the filter is lower than that of the waveguide. The duplexer described herein is one type of filters.

The microwave integrated circuit is generally welded onto the PCB to shorten the distance to the monolithic microwave integrated circuit, as described in the above. The antenna feeder parts refer to the parts such as a duplexer (filter) and an antenna. Currently, a metal case is generally used to construct these parts. If signals output from the integrated circuit to the PCB need to be led into these metal case structures, complex conversions are required, a great loss is caused, and the performance is reduced.

If the technology in the present disclosure is used, both the duplexer and the antenna are integrated on the PCB, so that these conversions can be avoided and the performance is improved. Finally, it should be noted that the foregoing embodiments are merely intended for describing the technical solutions of the present disclosure other than limiting the present disclosure.

Although the present disclosure is described in detail with reference to the foregoing embodiments, a person of ordinary skill in the art should understand that he may still make modifications to the technical solutions described in the foregoing embodiments, or make equivalent replacements to some technical features thereof, without departing from the spirit and scope of the technical solutions of the embodiments of the present disclosure.

What is claimed is:

1. A planar waveguide, comprising:
a top printed circuit board (PCB) having a groove;
a bottom PCB, wherein the groove and the bottom PCB form an air waveguide;
multiple shielding metal blocks, each shielding metal block having an upper surface contacting the top PCB and a lower surface contacting the bottom PCB;
a metal plate disposed on the upper surface of the top PCB;
a plurality of microstrips disposed on a lower surface of the top PCB, wherein the microstrips are positioned at both ends of the groove and are disposed along an extension line of the groove and wherein the multiple shielding metal blocks are disposed along an extension direction of the microstrips and the groove and are positioned on both sides of the microstrips and the groove; and
a first conversion piece configured to implement signal transmission between the microstrips and the air waveguide is further disposed between the microstrips and the bottom PCB under the groove;
wherein a working barycentric frequency of the planar waveguide is f0;
wherein a wavelength of an electromagnetic wave in the air under frequency f0 is λ=c/f0, where c is a velocity of light in the air;
wherein a height H_{b} of the shielding metal blocks fulfills 0.75×λ/4≦H_{b}≦1.25×λ/4;
wherein a width W_{b} of the shielding metal blocks fulfills λ/8≦W_{b}≦λ; and
wherein a gap W_{g} between the multiple shielding metal blocks fulfills 0<W_{g}≦λ/2.

2. The planar waveguide according to claim 1, wherein the planar waveguide further comprises a waveguide beam disposed on the bottom PCB and positioned exactly under the groove, a height of the waveguide beam me equal to the height of the shielding metal blocks; and
wherein the air waveguide is formed of the upper surface of the waveguide beam and the groove, one end of the first conversion piece being connected to the microstrips and another end of the first conversion piece being connected to the waveguide beam.

3. The planar waveguide according to claim 2, wherein the planar waveguide further comprises a second conversion piece, one end of the second conversion piece being connected to one end surface of the waveguide beam and another end of the second conversion piece being connected to the bottom PCB under the groove.

4. The planar waveguide according to claim 3, wherein a shape of the second conversion piece is a wedge, wherein a bottom of the wedge contacts the bottom PCB and a tip of the wedge is positioned on the bottom PCB.

5. The planar waveguide according to claim 1, wherein the first conversion piece is a metal fin or the first conversion piece is a wedge, a bottom of the wedge contacting the bottom PCB and a tip of the wedge being positioned on the bottom PCB.

6. The planar waveguide according to claim 5, wherein a length of the bottom of the wedge fulfills L_{q}≧λ/8, a thickness T_{q} of the tip of the wedge fulfills 0<T_{q}≦λ/8, and a lateral height H_{q} of the wedge is equal to the height H_{b} of the shielding metal blocks.

7. The planar waveguide according to claim 1, wherein the shielding metal blocks are a triangular prism, a cylinder, or a polygonal prism.

8. The planar waveguide according to claim 1, wherein a sidewall metallization is disposed in a window of the groove.

9. A waveguide filter, comprising:
a first planar waveguide according to claim 1; and
a second planar waveguide according to claim 1;
wherein the first and second planar waveguides are connected to each other; and
wherein the first and second planar waveguides has different impedances.

10. The waveguide filter according to claim 9, wherein the first planar waveguide further comprises a waveguide beam disposed on the bottom PCB and positioned exactly under the groove, a height of the waveguide beam being equal to the height of the shielding metal blocks; and
wherein the air waveguide is formed of the upper surface of the waveguide beam and the groove, one end of the first conversion piece being connected to the microstrips and another end of the first conversion piece being connected to the waveguide beam.

11. The waveguide filter according to claim 10, wherein the first planar waveguide further comprises a second conversion piece, one end of the second conversion piece being connected to one end surface of the waveguide beam and another end of the second conversion piece being connected to the bottom PCB under the groove.

12. The waveguide filter according to claim 11, wherein a shape of the second conversion piece is a wedge, a bottom of the wedge contacting the bottom PCB and a tip of the wedge being positioned on the bottom PCB.

13. The waveguide filter according to claim 9, wherein the first conversion piece is a metal fin or the first conversion piece is a wedge, the bottom of the wedge contacting the bottom PCB and a tip of the wedge being positioned on the bottom PCB.

14. The waveguide filter according to claim 13, wherein a length of the bottom of the wedge fulfills L_{q}≧λ/8, a thickness T_{q} of the tip of the wedge fulfills 0<T_{q}≦λ/8, and a lateral height H_{q} of the wedge is equal to the height H_{b} of the shielding metal blocks.

15. An antenna, comprising the planar waveguide according to claim 1, wherein a window is disposed on a metal plate of the planar waveguide, the window being positioned above a groove of a top PCB of the planar waveguide, a width Wₛ of the window fulfills 0<Wₛ≦λ/2, and a length Lₛ of the window fulfills 0<Lₛ≦λ/8.

16. The antenna according to claim 15, wherein the planar waveguide further comprises a waveguide beam disposed on the bottom PCB and positioned exactly under the groove, a height of the waveguide beam being equal to the height of the shielding metal blocks; and
wherein the air waveguide is formed of the upper surface of the waveguide beam and the groove, one end of the first conversion piece being connected to the microstrips and another end of the first conversion piece being connected to the waveguide beam.

17. The antenna according to claim 16, wherein the planar waveguide further comprises a second conversion piece, one end of the second conversion piece being connected to one end surface of the waveguide beam and another end of the second conversion piece being connected to the bottom PCB under the groove.

18. The antenna according to claim 17, wherein a shape of the second conversion piece is a wedge, the bottom of the wedge contacting the bottom PCB and a tip of the wedge being positioned on the bottom PCB.

19. The antenna according to claim 15, wherein the first conversion piece is a metal fin or the first conversion piece is a wedge, a bottom of the wedge contacting the bottom PCB and a tip of the wedge being positioned on the bottom PCB.

20. The antenna according to claim 19, wherein a length of the bottom of the wedge fulfills L_{q}≧λ/8, a thickness T_{q} of the tip of the wedge fulfills 0<T_{q}≦λ/8, and a lateral height H_{q} of the wedge is equal to the height H_{b} of the shielding metal blocks.
